(19) United States
(12) Patent Application Publication
(10) Pub. No.: US 2006/0096268 A1
(43) Pub. Date: May 11, 2006

(54) Maximum propulsion attachment for grass mower

(76) Inventor: Joseph Edward Kohler, Aurora, OH (US)

Correspondence Address: JOSEPH E. KOHLER, 3640 NAUTILUS, AURORA, OH, 44202, US

(21) Appl. No.: 10/978,490

(22) Filed: Nov. 1, 2004

(51) Int. Cl. A01D 45/02

(52) U.S. Cl. 56/100

(57) ABSTRACT

This device attaches to drive tires of walk-behind grass mowers to provide several new advantages. Foremost, the drive tire grip to uncut grass is more than increased, it is maximized, resulting in a true self-propelled, walk-behind mower. No pushing is required, even when ascending steep inclines. Thus, minimum time and effort is expended to mow lawns. By attaching this device to old and worn drive tires, they are easily, quickly, and economically, given better than new performance. Finally, by attaching this device to grass mower drive tires, this new assembly lasts many times longer than the original.

### BACKGROUND OF THE INVENTION

1. Field of Invention

This invention relates to self-propelled, walk-behind, grass mowers

2. Prior Art

Walk-behind grass mowers have evolved to two basic types. The economy model has no propulsion system. It depends on the operator for the driving force. This can become a grueling experience.

The luxury model is self-propelled. A motor drives the cutting mechanism and rotates two tires. This type mower has drive tires either ahead of the cutting mechanism or behind the cutting mechanism. With this class of mower, the operator is led to expect complete relief of exertion. As we shall see, the operator gets something less.

Now, self-propelled, walk-behind mowers utilize 8 inch diameter tires of a rubber like material with some type of tread pattern. To uncloak the not so obvious defective prior art propulsion, two tools are needed: A 0-50 pound fish spring scale and the concept of coefficient of friction.

Let Mu be the coefficient of friction. Let an object rest on a horizontal surface and its weight acting vertical on the surface be N. let a friction force F act horizontal on the object with a magnitude to just start the object in motion. Then,
Mu=F/N Or, more often used, F=(Mu)N

Mu has no dimensions and is almost always less than 1.0 for various materials. Now using the fish spring scale, it is found that only 25 pounds is required to lift the front end of a front wheel drive mower. Using the fish spring scale, it is found that 40 pounds is required to lift the rear end of a rear drive mower. The rear end supports the weights of controls, transmission and operator handle bar.

In the equation above, hereinafter, the force F is replaced with and is identical to the propulsive force. Observe that the equation states that the propulsive force increases as more weight is placed on the driver wheels. And vice versa. This is a fact which plagues all walk-behind grass mowers.

Mark's Engineering Handbook lists the coefficient of friction for many materials. For a rubber tire on concrete, the stated value is 0.5-0.7. Thus, for the described mowers on concrete, the propelling force can be (0.6)25=15 pounds or (0.6)40=28 pounds.

Now the fish spring scale is used to determine the force needed to pull either of the described mowers in free wheel on a concrete surface. It is 5-7 pounds.

Indeed, both mowers move smartly along on concrete and can even negotiate steep inclines. This would be the surface of choice for a salesperson to demonstrate the mower to a potential customer.

Now the mower is placed on uncut grass, tires free to turn. The fish spring scale indicates a force of 18-22 pounds to move the mower. This is about four times the force to move on concrete.

The coefficient of friction of tire to grass can be found. The driver wheels of the mower are engaged to the motor, but the motor not started. The fish spring scale now shows a force of 27 pounds is needed to move the mower. The rise of 5-9 pounds is all the tires can produce on grass. But 18-22 lbs is needed. The missing force of 9-13 pounds is supplied by the luckless operator. The coefficient of friction here is a paltry 0.2-0.3.

Amazingly, the conditions of driving on concrete are exactly reversed. Four times more propulsion is needed, but only half is available!

To simulate and measure the few mowers fitted with very aggressive tire treads, huge “knobbies”, such as seen on mountain bikes, may be bonded to the regular tires.

With the mower placed on uncut grass and the drive wheels locked, the fish spring scale may be used to drag the mower. A force of 35 pounds is then viewed. There is a net force of 12-17 pounds lbs. available for propulsion. The coefficient of friction has doubled to 0.48-0.70, but the unsuspecting operator still supplies a few pounds of push.

Nevertheless, all the self-propelled, walk-behind lawn mowers suffer a number of serious, not so obvious disadvantages:
(a) Some degree of pushing is required on level, uncut grass. When the operator drives onto dew covered grass, even more is needed
(b) Pushing is always required to go up inclines.
(c) Driver tires become worn soon because they are always slipping.
(d) Replacing worn drive wheels is difficult, time consuming and costly.
(e) Since drive tires are always slipping more mowing time is needed
(f) Last but not least, prior art walk-behind grass mowers are drudgery to use. Without exception, each model causes unnecessary fatigue.

### BACKGROUND OF INVENTION—OBJECTS AND ADVANTAGES

My invention may be easily attached to the drive tires of a walk-behind, self-propelled grass mower. This mower may be placed on uncut grass with the drive wheels locked. The fish spring scale may be connected to the mower and an increasing force applied by the scale to drag the mower. The fish spring scale will peg at 50 pounds and the grass mower will not yet move. The required propulsive force is thus exceeded by several pounds and the coefficient of friction is greater than 1.00. Accordingly, several objects and advantages of the present invention are:
(a) No degree of pushing is needed by an operator to move the grass mower on level, uncut grass whether the grass is wet or dry.
(b) Pushing the mower is not required to climb steep inclines
(c) The surface of the driver tire does not wear. Compared to the standard tire lifespan, the invention lifespan is much longer.
(d) Replacing the worn tire surface with my invention is easy, quick, and inexpensive.
(e) Because there is no loss of traction of the grass mower driving wheels, the actual time needed to mow any area of grass is minimized.
(f) Last but not least, when my invention is fitted to any self-propelled, walk-behind grass mower, fatigue is replaced by the effortless new operation of the mower. It is positively exhilarating for the operator to be pulled up hill.

Less the reader be concerned that this extra performance will be paid for by extra loading of the transmission system, use the definition of horsepower, 550 ft.lbs/second to apply to the 3 feet/second velocity and 20 lbs. force of the mower. A mere 0.10 horsepower is used.

### SUMMARY

In accordance with my invention, the partial loss of needed propulsion inherent in light weight grass mowers is totally corrected. It is shown that this is not possible with prior art, due to the limit of coefficient of friction between uncut grass and prior art tires. Not so obvious other benefits result. Less time and effort to mow the lawn follows. There is a reduction of costs for mower maintaince.

### DRAWINGS—FIGURES

FIG. 1 is a perspective view of my invention showing all essential parts.

FIG. 2 is a perspective view of a typical walk-behind, self-propelled grass mower of front wheel drive configuration. This is prior art.

FIG. 3 is the enlarged front portion of the mower depicted in FIG. 2, showing the invention attached to the front drive tire.

### DRAWINGS—REFERENCE NUMERALS

11 prior art drive tire
12 thin band
13 thin paddle
14 90 degree bend of band
15 bend opposite end of band
16 hole on end of bend 14
17 hole on opposite end of bend 14
18 hole on end of bend 15
19 hole on opposite end of bend 15
20 a machine bolt through holes 16, and hole 18
21 a machine bolt through holes 17, and hole 19
22 a hex nut able to thread on bolt 20
23 a hex nut able to thread on bolt 21

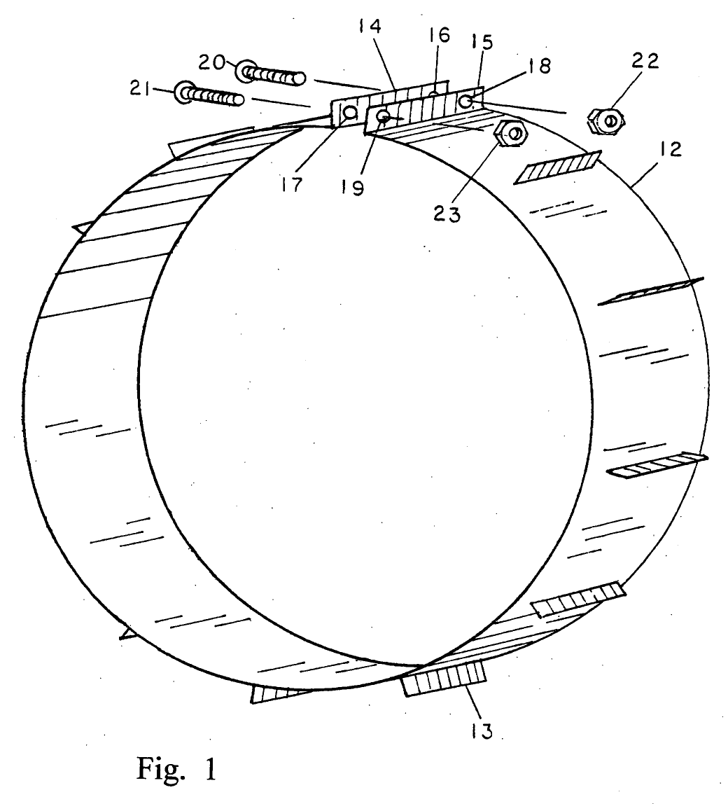

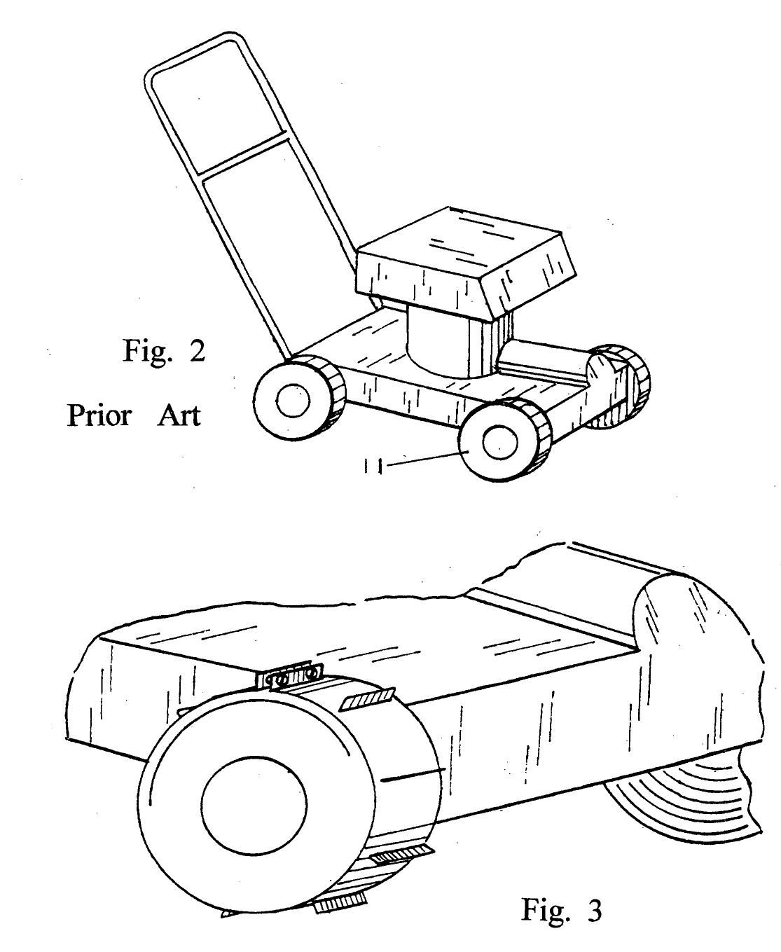

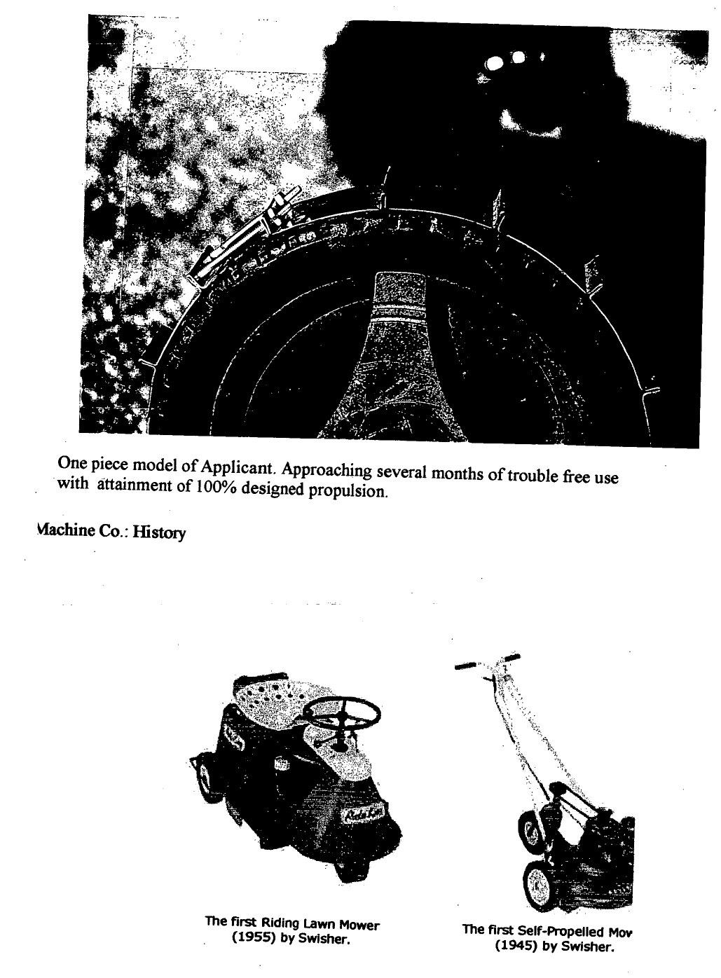

### DETAILED DESCRIPTION PREFERRED EMBODIMENT—FIG. 1 TO FIG. 3

FIG. 1 shows a basic perspective of the invention. The thin band 12 is 2 inches wide, 25 inches long and 0.032-0.060 inches thick metal. Hard brass is a suitable material, as soldering of parts to it will follow. I used a door kick plate to fashion all sheet parts.

The thin paddle 13 is ¼ inch wide, 1½ long and also fabricated from the same material as thin band 12. There are 15 paddles soldered to the thin band 12 at a spacing every 1.5 inches. If one uses a lesser spacing with more paddles, the coefficient of friction to grass diminishes. If fewer paddles are used at a greater spacing, you will get something you won't like, grass demolition.

But, before any soldering is commenced, it is easiest to make 90 degree bends of ¼ inch height on each end of the thin metal band, 12. These are bend 14 and bend 15. Fabricate a ⅛ diameter hole at each of the four corners of bend 14 and bend 15. This is hole 16, hole 17, hole 18, and hole 19. A 6-32 thread machine bolt 20 is ¾ inch long and is inserted through hole 16, and hole 18. An identical bolt 21 is inserted through hole 17 and hole 19. Hex nut 22 is threaded on bolt 20 and hex nut 23 is threaded on bolt 21. The thin band 12 is now of a circular shape.

Now solder fifteen of thin paddle 13 at 1.5 inch intervals to thin band 12 such that they are perpendicular to the 25 inch dimension of thin band 12 and ¼ inch from its edge. Make two such assemblies as shown in FIG. 1.

### Comments on the Preferred Embodiment in FIG. 1

The embodiment depicted in FIG. 1 represents a construction using simple tools and materials of average artisans. Thus, the benefits of the invention become available to those who desire it at some effort.

It is apparent that the invention could be mass produced using tooling. The tooling could eliminate joining of parts by simply stamping the invention in one piece. It is also conceivable under claim 1 to initiate the invention as original equipment. That is, the self-propelled grass mower would leave the factory with the invention built in.

### Operation of the Invention

FIG. 1 contains all essential parts of my invention which can now be described as to function, and where applicable, operation.

Begin by blocking the mower drive tires slightly off the ground. Slide the invention over each drive tire. Secure it in place by tightening hex nut 22 and hex nut 23 until bend 14 is within ¼ inch of bend 15. Place the mower off the block and use in a normal fashion. The invention will not damage asphalt or concrete.

The multiplicity of paddle 13, being thin and spaced significanty away from others have a resulting high unit loading and thus indent well into the grass. That is, paddles penetrate the grass surface. There is a degree of locking to the grass and sod. One may begin to believe that using the theory of coefficient of friction relates to surfaces that slide past each other and is irrelevant here. Not so. A measure of friction is a measure of the force needed to snap off minute protuberances of matter which have penetrated each others surface, Exactly here. The heart of this invention is the thin paddle digging past the surface of grass. The resulting coefficient of friction between uncut grass and the invention is greater than 1.0. A rare achievement by any measure.

### Conclusion, Ramification and Scope of the Invention

Thus, the reader will understand that this invention provides highly desireable improvements for self-propelled, walk-behind grass mowers. These teachings show the modest advantage of propulsion by rear drive mowers over front wheel drive mowers due to the increased weight acting on the rear tires. The reader will understand the invention is able to serve the described benefits particularly to the light weight walk behind grass mowers.

While my description contains many specificities, these should not be construed as limitations on the scope of the invention, but rather as an exemplification of one type embodiment thereof.

It was pointed out previously under comments how variants would be created using various methods of manufacture. The invention made with tooling would bear little resemblence to FIG. 1.

For the very few models of walk-behind mowers fitted with other diameter wheels, there should be no impediment to modify relevant descriptions so as to present to these grass mowers all the advantages of this invention.

1-10. (canceled)

11-12. (canceled)

13. An attachment to a self-propelled, walk-behind, grass mower to maximize propulsion, comprising a thin band of preferably corrosion-resistant metal, easily clamped to the periphery of each drive tire by means of suitable and easily obtained, off-the-shelf joining hardware, and said thin band featuring small, thin, paddles integrally formed or securely attached orthogonal to the surface and long edge of said thin band.

14. An attachment to a self-propelled, walk-behind, grass mower to maximize propulsion as set forth in claim 13, characterized further in that said thin paddles are spaced about 1½ inch apart and of rectangular shape, of height a fraction of an inch, and length about the width of said thin band which is about the width of the drive tire, and there being a 90 degree bend of thin band at each end with two matching holes in each to allow two bolts and nuts to clamp the attachment to each drive tire.
